(19) United States
(12) Patent Application Publication
(10) Pub. No.: US 2024/0076924 A1
(43) Pub. Date: Mar. 7, 2024

(54) PREVENTING FINGER OF A USER FROM PINCH IN A DOOR GAP

(71) Applicant: Mirza Faizan, Irving, CA (US)

(72) Inventors: Mirza Faizan, Irving, CA (US); Ayat Faizan, Irving, CA (US); Vihan Yerubandi, South Lake, TX (US)

(21) Appl. No.: 17/902,948

(22) Filed: Sep. 5, 2022

(51) Int. Cl. E05F 15/43; E05C 17/02

(52) U.S. Cl. CPC E05F 15/43; E05C 17/02

(57) ABSTRACT

Embodiments of the present disclosure provide a method for preventing a finger of a user from pinch in a door gap. The method comprises detecting a position of one or more fingers of a user using at least one sensor mounted on a door, determining whether the position of the one or more fingers of the user is in a door gap of the door, generating a signal to stop the moving panel of the door based on the determination that the position of the one or more fingers of the user is in the door gap of the door, transmitting the signal to a door stopper mounted on the door, and preventing a closure of the door by maintaining a distance between the frame and the moving panel of the door based on the signal.

The corresponding system and computer-readable storage medium is also disclosed.

### TECHNICAL FIELD

The present disclosure relates generally to child safety. More particularly, it relates to prevention of a finger of a child from pinch in a door gap.

### BACKGROUND

In daily life, the hand of a person specially a child may accidently put their finger is a door gap of a door. This leads to various accidents such as crushed or pinch off finger. In particular, children are more fond of play and often put their finger in the door gap. The self-care ability of the children is poor which easily make injury to the children.

Conventionally, doors are mounted in a rotational engagement using hinge pins secured to a door jamb wall. In this rotatable engagement the door is free to rotate about its hinges from an open position extending at an angle from the wall supporting a door jamb, to a closed position substantially flush with the wall and surrounded by the door jamb on four sides. Because of the size and mass of most doors and the relatively small area between the side edges of the door and the surface of the surrounding door jamb, a great amount of force may be generated by a closing door. This force combined with a perpendicular leading angle to a closing door approaching the jamb can cause severe injury to the fingers of a child or to a child's hand that is in the wrong position as the door closes. With young children in the house, and in some cases even adults, finger injuries from closing doors have become ever more common and severe injury or amputation can occur when a finger becomes caught or pinched between the leading edge of a closing door and the door jamb in the wall.

An additional concern is damage to the door and jamb themselves should any objects be intentionally or accidentally positioned between the door and jamb from a deliberate or accidental insertion. This type of problem can occur when children are playing with a door or slamming it or inserting toys or objects to prevent closure by another child.

Thus, there is a need of providing a method for automatically detect the presence of a finger of a user in the door gap and automatically stop the panel of the door.

### SUMMARY

Consequently, there is a need for an improved method and arrangement for implementing a method and system that alleviates at least some of the above-cited problems.

It is therefore an object of the present disclosure to provide a system and a method for preventing a finger of a user from pinch in a door gap to mitigate, alleviate, or eliminate all or at least some of the above-discussed drawbacks of presently known solutions.

This and other objects are achieved using a system and a method as defined in the appended claims. The term exemplary is in the present context to be understood as serving as an instance, example or illustration.

According to the first aspect of the present disclosure, a method for preventing a finger of a user from pinch in a door gap is disclosed. The method comprises detecting a position of one or more fingers of a user using at least one sensor mounted on a door. The method further comprises determining whether the position of the one or more fingers of the user is in a door gap of the door, wherein the door gap is a gap between a frame of the door and a moving panel of the door. The method further comprises generating a signal to stop the moving panel of the door based on the determination that the position of the one or more fingers of the user is in the door gap of the door. The method further comprises transmitting the signal to a door stopper mounted on the door, wherein the signal instructs the door stopper to stop the moving door panel of the door. The method further comprises preventing a closure of the door by maintaining a distance between the frame and the moving panel of the door based on the signal.

In some embodiments, the user is a child.

In some embodiments, the at least one sensor includes one or more of a Time-of-Flight (ToF) camera, a touch sensor, a Light Detection and Ranging (LiDAR) sensor, and an ultrasonic sensor.

In some embodiments, the at least one sensor is communicatively connected to the door stopper.

In some embodiments, the at least one camera is mounted on the door at one or more of a top of the frame of the door, a bottom of the frame of the door, each side of the frame of the door, and the any portion of the moving panel of the door.

In some embodiments, an alert message is transmitted to an alarm system based on the determination that the position of the one or more fingers of the user is in the door gap of the door.

In some embodiments, the distance to be maintained between the frame and the moving panel of the door is defined by an operator of the door.

In some embodiments, the signal is transmitted to the door stopper through one of a wireless connection or a wired connection.

According to a second aspect of the present disclosure, a system for preventing a finger of a user from pinch in a door gap is disclosed. The system comprises a processor and a memory storing programmed instructions executable by the processor, wherein the processor executes the programmed instructions. The processor is configured to detect a position of one or more fingers of a user using at least one sensor mounted on a door. The processor is further configured to determine whether the position of the one or more fingers of the user is in a door gap of the door, the door gap is a gap between a frame of the door and a moving panel of the door. The processor is further configured to generate a signal to stop the moving panel of the door based on the determination that the position of the one or more fingers of the user is in the door gap of the door. The processor is further configured to transmit the signal to a door stopper mounted on the door, wherein the signal instructs the door stopper to stop the moving door panel of the door. The processor is further configured to prevent a closure of the door by maintaining a distance between the frame and the moving panel of the door based on the signal.

In some embodiments, the at least one sensor includes one or more of a Time-of-Flight (ToF) camera, a touch sensor, a Light Detection and Ranging (LiDAR) sensor, and an ultrasonic sensor.

In some embodiments, the at least one sensor is communicatively connected to the door stopper.

In some embodiments, the at least one camera is mounted on the door at one or more of a top of the frame of the door, a bottom of the frame of the door, each side of the frame of the door, and the any portion of the moving panel of the door.

In some embodiments, an alert message is transmitted to an alarm system based on the determination that the position of the one or more fingers of the user is in the door gap of the door.

In some embodiments, the distance to be maintained between the frame and the moving panel of the door is defined by an operator of the door.

In some embodiments, the signal is transmitted to the door stopper through one of a wireless connection or a wired connection.

According to a third aspect of the present disclosure, a non-transitory computer-readable storage medium for computing a desired result based on user's requirements, having stored thereon, a set of computer-executable instructions causing a computer comprising one or more processors. the one or more processors causing detecting a position of one or more fingers of a user using at least one sensor mounted on a door. One or more processors causing determining whether the position of the one or more fingers of the user is in a door gap of the door, the door gap is a gap between a frame of the door and a moving panel of the door. The one or more processors causing generating a signal to stop the moving panel of the door based on the determination that the position of the one or more fingers of the user is in the door gap of the door. The one or more processors causing transmitting the signal to a door stopper mounted on the door, wherein the signal instructs the door stopper to stop the moving door panel of the door. The one or more processors causing preventing a closure of the door by maintaining a distance between the frame and the moving panel of the door based on the signal.

In some embodiments, any of the above aspects may additionally have features identical with or corresponding to any of the various features as explained above for any of the other aspects.

An advantage of some embodiments is that alternative and/or improved approaches are provided for preventing a finger of a user from pinch in a door gap.

An advantage of some embodiments is that the problem is identified to provide the required solution for problems related to child safety.

An advantage of some embodiments is to automatically detect a finger present in the door gap.

An advantage of some embodiments is automatically stop the door panel of the door.

An advantage of some embodiments is that the door is stopped without any human intervention.

### BRIEF DESCRIPTION OF THE DRAWINGS

The foregoing will be apparent from the following more particular description of the example embodiments, as illustrated in the accompanying drawings in which reference characters refer to the same parts throughout the different views. The drawings are not necessarily to scale, emphasis instead being placed upon illustrating the example embodiments.

FIG. 1 illustrates a diagram of a door installed in a room, according to some embodiments of the present invention.

FIG. 2 illustrates presence of fingers in the door gap of the door, according to some embodiments of the present invention.

FIG. 3 illustrates a block diagram of system for preventing a finger of a user from pinch in a door gap, according to some embodiments of the present invention.

FIG. 4 illustrates a flow diagram of method steps for preventing a finger of a user from pinch in a door gap, according to some embodiments of the present invention.

FIG. 5 illustrates an example computing environment implementing a method and the processing node for preventing a finger of a user from pinch in a door gap, according to some embodiment of the present invention.

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an”, and “the” are intended to include the plural forms as well, unless the context clearly indicates otherwise.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services, and functions disclosed herein when executed by the one or more processors.

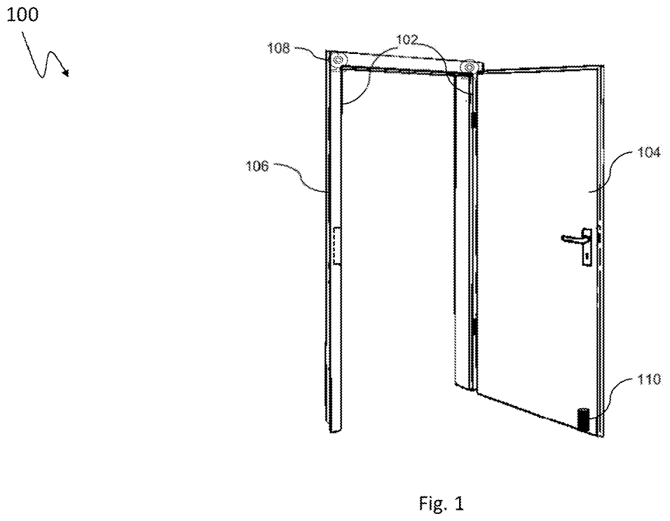

FIG. 1 illustrates a diagram of a door 100 installed in a room, according to some embodiments of the present invention. Some of the examples of the door 100 may include, but not limited to, a slide door, a latch door, and a revolving door. The door 100 may comprise a door gap 102, a door panel 104, a frame 106, one or more sensors 108, and a door stopper 110. The door gap 102 may be present at both ends of the frame 106 of the door 100. The door gap 102 may be adapted to accommodate the door panel 104 of the door 100. The door panel 104 may be present in a vertical direction. The door panel 104 may be adapted to move in rotational direction for closing and opening the door 100.

The sensor 108 may include, but not limited to, a Time-of-Flight (ToF) camera, a touch sensor, a Light Detection and Ranging (LiDAR) sensor, and an ultrasonic sensor. The sensor 108 may be present at different positions on the frame 106 of the door 100. In one implementation, the sensor 108 may be present at top-right corner of the frame 106 of the door 100. In another embodiment, the sensor 108 may be present at top-left corner of the frame 106 of the door 100. In another embodiment, the sensor 108 may be present at top-left as well as top-right corner of the frame 106 of the door 100.

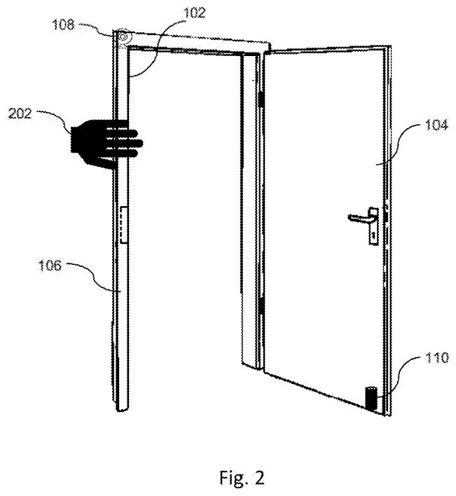

FIG. 2 illustrates presence of fingers 202 in the door gap 102 of the door 100, according to some embodiments of the present invention. The sensor 108 may be configured to detect presence of fingers 202 in the door gap 102 of the door 100. For example, the sensor 108 may be positioned such that a field of view of the sensor 108 is same as door gap 102 of the door 100. When any part of body (such as a finger 202) of the user (such as a child) is detected in the field of view of the sensor 108.

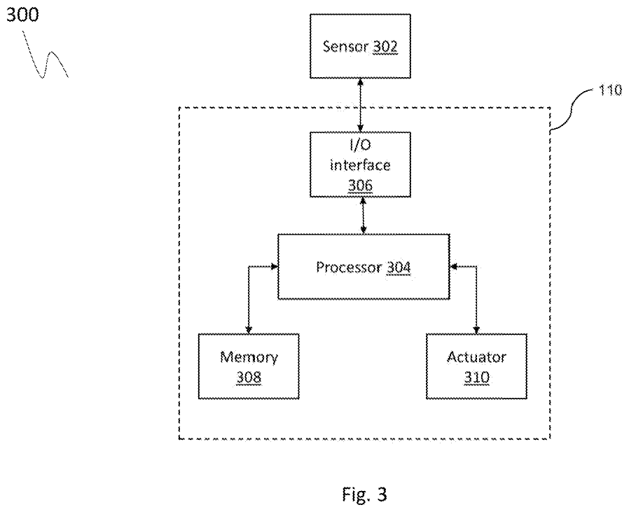

The sensor 108 may transmit a signal to a door stopper 110 of the door. The door stopper 110 may be configured to stop the movement of the door panel 106. Various components of the door stopper 110 has been described with reference to FIG. 3.

As illustrated in FIG. 3, the door stopper 110 may receive a signal from a sensor 302 (similar to the sensor 108 as illustrated in FIGS. 1 and 2). The sensor 302 may be configured to sense or detect presence of a user's hand in door gap 102 of the door 100. The door stopper 110 may comprise a processor 304, an I/O interface 306, a memory 308, and an actuator 310.

The processor 304 may receive the signal from the sensor 302 through the I/O interface 306. The signal may indicate presence of user's hand in the door gap 102 of the door 100. The processor 304 may be communicatively coupled with the memory 308. The memory 308 may be configured to store programmed instructions executable by the processor 304. The processor 304 may execute the programmed instructions to perform one or more steps for preventing user's finger from pinching in a door gap 102.

In one or more embodiments, the processor 304 may detect a position of one or more fingers of a user using at least one sensor mounted on a door. The processor 304 may further determine whether the position of the one or more fingers of the user is in a door gap of the door. The door gap is a gap between a frame 106 of the door and a moving panel of the door. The processor 304 may further determine generate a signal to stop the moving panel of the door based on the determination that the position of the one or more fingers of the user is in the door gap of the door. The processor 304 may further transmit the signal to the actuator 310. The signal instructs the actuator 310 to stop the moving door panel 104 of the door 100.

The actuator 310 may comprise one or more components for blocking the movement of the door panel 104. When the actuator 310 receives the signal to stop the movement of the door panel 104, it automatically restricts the movement of the door panel 104, thereby preventing the user's finger from pinch in the door gap 102. For example, the actuator 310 may be comprised with a mechanism which move downward and couple with the ground to restrict the movement of the door panel 104.

The user may be a child or any person who can accidently put their finger in the door gap 102. The sensor 302 may include one or more of a Time-of-Flight (ToF) camera, a Light Detection and Ranging (LiDAR) sensor, and an ultrasonic sensor. The sensor 302 may be mounted on the door 100 at one or more of a top of the frame 106 of the door 100, a bottom of the frame 106 of the door 100, each side of the frame 106 of the door 100, and the any portion of the moving panel of the door 100.

The system may further comprise an alarm system which transmits an alarm message or generate alarm sounds when it is determined that the user's finger is present in the door gap 102 of the door 100. The distance to be maintained between the frame 106 and the moving panel 104 of the door 100 is defined by an operator of the door 100. The signal may be transmitted to the door stopper 110 through one of a wireless connection or a wired connection.

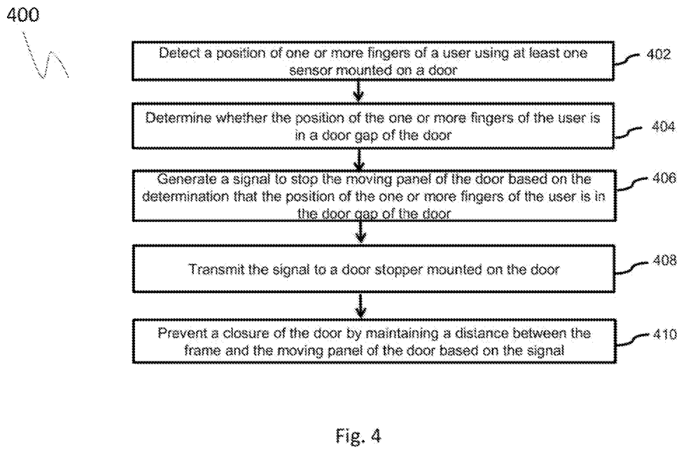

FIG. 4 illustrates a flow diagram of method steps for preventing a finger of a user from pinch in a door gap, according to some embodiments of the present invention. A position of one or more fingers of a user may be detected using at least one sensor mounted on a door, at step 402. It may be determined whether the position of the one or more fingers of the user is in a door gap of the door, at step 404. The door gap is a gap between a frame of the door and a moving panel of the door. A signal to stop the moving panel of the door may be generated based on the determination that the position of the one or more fingers of the user is in the door gap of the door, at step 406. The signal may be transmitted to a door stopper mounted on the door, at step 408. The signal instructs the door stopper to stop the moving door panel of the door. A closure of the door may be prevented by maintaining a distance between the frame and the moving panel of the door based on the signal, at step 410.

The user may be a child or any person who can accidently put their finger in the door gap. The sensor may include one or more of a Time-of-Flight (ToF) camera, a Light Detection and Ranging (LiDAR) sensor, and an ultrasonic sensor. The sensor may be mounted on the door at one or more of a top of the frame of the door, a bottom of the frame of the door, each side of the frame of the door, and the any portion of the moving panel of the door.

An alarm system may be present which transmits an alarm message or generate alarm sounds when it is determined that the user's finger is present in the door gap of the door. The distance to be maintained between the frame and the moving panel of the door is defined by an operator of the door. For example, the distance to be maintained by the processor is predefined by used and whenever the processor detects the finger, it instructs the door stopper to stop the door to maintain that predefined distance. The signal may be transmitted to the door stopper through one of a wireless connection or a wired connection.

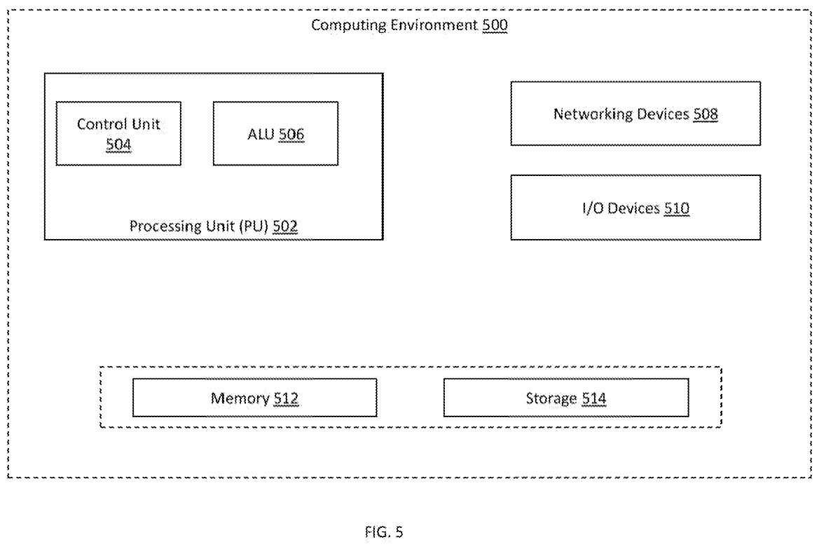

FIG. 5 illustrates an example computing environment 500 implementing a method and the processing node for preventing a finger of a user from pinch in a door gap, according to some embodiment of the present invention. The computing environment 500 may be coupled with the door stopper of the door. As depicted in FIG. 5, the computing environment 500 comprises at least one processing unit 502 that is equipped with a control unit 504 and an Arithmetic Logic Unit (ALU) 506, a plurality of network devices 508 and a plurality Input-output, I/O devices 510, a memory 512, and a storage 514. The processing unit 502 may be responsible for implementing the method described in FIG. 4. For example, the processing unit 502 may in some embodiments be equivalent to the processor of the processing node and the server described above in conjunction with the FIG. 4. The processing unit 502 is capable of executing software instructions stored in memory 512. The processing unit 502 receives commands from the control unit 504 in order to perform its processing. Further, any logical and arithmetic operations involved in the execution of the instructions are computed with the help of the ALU 506.

The computer program is loadable into the processing unit 502, which may, for example, be comprised of an electronic apparatus (such as a UE or a network node). When loaded into the processing unit 502, the computer program may be stored in the memory 512 associated with or comprised in the processing unit 502. According to some embodiments, the computer program may, when loaded into and run by the processing unit 502, cause execution of method steps according to, for example, any of the methods illustrated in FIG. 4 or otherwise described herein.

The overall computing environment 500 may be composed of multiple homogeneous and/or heterogeneous cores, multiple CPUs of different kinds, special media, and other accelerators. Further, the plurality of processing unit 502 may be located on a single chip or over multiple chips.

The algorithm comprising of instructions and codes required for the implementation are stored in either the memory 512 or the storage 514 or both. At the time of execution, the instructions may be fetched from the corresponding memory 512 and/or storage 514 and executed by the processing unit 502.

In case of any hardware implementations various networking devices, 508 or external I/O devices 510 may be connected to the computing environment to support the implementation through the networking devices 508 and the I/O devices 510.

The embodiments disclosed herein can be implemented through at least one software program running on at least one hardware device and performing network management functions to control the elements. The elements shown in FIG. 5 include blocks that can be at least one of a hardware device or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user's computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer-readable media such as RAMs, ROMs, flash memory, EEPROMs, optical devices (CD or DVD), hard drives, and floppy drives, or any suitable device. The computer-executable component can be a processor but any suitable dedicated hardware device can (alternatively or additionally) execute the instructions.

As a person skilled in the art will recognize from the previous detailed description and the figures and claims, modifications and changes can be made to the embodiments of the invention without departing from the spirit and scope of this invention as defined in the following claims.

We claim:

1. A method for preventing a finger of a user from pinch in a door gap, the method comprising:
detecting a position of one or more fingers of a user using at least one sensor mounted on a door;
determining whether the position of the one or more fingers of the user is in a door gap of the door, wherein the door gap is a gap between a frame of the door and a moving panel of the door;
generating a signal to stop the moving panel of the door based on the determination that the position of the one or more fingers of the user is in the door gap of the door;
transmitting the signal to a door stopper mounted on the door, wherein the signal instructs the door stopper to stop the moving door panel of the door; and
preventing a closure of the door by maintaining a distance between the frame and the moving panel of the door based on the signal.

2. The method as claimed in claim 1, wherein the user is a child.

3. The method as claimed in claim 1, wherein the at least one sensor includes one or more of a Time-of-Flight (ToF) camera, a touch sensor, a Light Detection and Ranging (LiDAR) sensor, and an ultrasonic sensor.

4. The method as claimed in claim 1, wherein the at least one sensor is communicatively connected to the door stopper.

5. The method as claimed in claim 1, wherein the at least one camera is mounted on the door at one or more of a top of the frame of the door, a bottom of the frame of the door, each side of the frame of the door, and the any portion of the moving panel of the door.

6. The method as claimed in claim 1, wherein an alert message is transmitted to an alarm system based on the determination that the position of the one or more fingers of the user is in the door gap of the door.

7. The method as claimed in claim 1, wherein the distance to be maintained between the frame and the moving panel of the door is defined by an operator of the door.

8. The method as claimed in claim 1, wherein the signal is transmitted to the door stopper through one of a wireless connection or a wired connection.

9. A system for preventing a finger of a user from pinch in a door gap, the system comprising:
a processor; and
a memory storing programmed instructions executable by the processor, wherein the processor executes the programmed instructions to:
detect a position of one or more fingers of a user using at least one sensor mounted on a door;
determine whether the position of the one or more fingers of the user is in a door gap of the door, wherein the door gap is a gap between a frame of the door and a moving panel of the door;
generate a signal to stop the moving panel of the door based on the determination that the position of the one or more fingers of the user is in the door gap of the door;
transmit the signal to a door stopper mounted on the door, wherein the signal instructs the door stopper to stop the moving door panel of the door; and
prevent a closure of the door by maintaining a distance between the frame and the moving panel of the door based on the signal.

10. The system as claimed in claim 9, wherein the user is a child.

11. The system as claimed in claim 9, wherein the at least one sensor includes one or more of a Time-of-Flight (ToF) camera, a touch sensor, a Light Detection and Ranging (LiDAR) sensor, and an ultrasonic sensor.

12. The system as claimed in claim 9, wherein the at least one sensor is communicatively connected to the door stopper.

13. The system as claimed in claim 9, wherein the at least one camera is mounted on the door at one or more of a top of the frame of the door, a bottom of the frame of the door, each side of the frame of the door, and the any portion of the moving panel of the door.

14. The system as claimed in claim 9, wherein an alert message is transmitted to an alarm system based on the determination that the position of the one or more fingers of the user is in the door gap of the door.

15. The system as claimed in claim 9, wherein the distance to be maintained between the frame and the moving panel of the door is defined by an operator of the door.

16. The system as claimed in claim 9, wherein the signal is transmitted to the door stopper through one of a wireless connection or a wired connection.

17. A non-transitory computer-readable storage medium for computing a desired result based on user's requirements, having stored thereon, a set of computer-executable instructions causing a computer comprising one or more processors to perform steps comprising:
detecting a position of one or more fingers of a user using at least one sensor mounted on a door;
determining whether the position of the one or more fingers of the user is in a door gap of the door, the door gap is a gap between a frame of the door and a moving panel of the door;
generating a signal to stop the moving panel of the door based on the determination that the position of the one or more fingers of the user is in the door gap of the door;
transmitting the signal to a door stopper mounted on the door, wherein the signal instructs the door stopper to stop the moving door panel of the door; and
preventing a closure of the door by maintaining a distance between the frame and the moving panel of the door based on the signal.
